(19) United States
(12) Patent Application Publication
(10) Pub. No.: US 2016/0087666 A1
(43) Pub. Date: Mar. 24, 2016

(54) ELECTRONIC DEVICE

(71) Applicants: Fu Tai Hua Industry (Shenzhen) Co., Ltd., Shenzhen (CN); HON HAI PRECISION INDUSTRY CO., LTD., New Taipei (TW)

(72) Inventor: QIAN LEI, Shenzhen (CN)

(21) Appl. No.: 14/585,932

(22) Filed: Dec. 30, 2014

(30) Foreign Application Priority Data
Sep. 24, 2014 (CN) 201410492739.9

(51) Int. Cl. H04B 1/3818

(52) U.S. Cl. CPC H04B 1/3818

(57) ABSTRACT

An electronic device includes a first shell defining a first opening; a power module received in the first shell; and an electronic card connector including a tray passing through the first opening to be received in the first shell, and a receiving member attached to the first shell for receiving the tray. The electronic card connector includes a permanent magnet mounted in the tray and an electromagnet attached to the first shell and facing the permanent magnet. The electronic device further includes a current control module electrically coupled with the power module and configured to control the power module to magnetize or de-magnetize the electromagnet. When the electromagnet is de-magnetized, the tray is attracted by the permanent magnet to engage the tray with the first shell. When the electromagnet is magnetized, the tray is driven to disengage the tray with the first shell by the permanent magnet.

### FIELD

The subject matter herein generally relates to an electronic device having an electronic card connector.

### BACKGROUND

Electronic card connector, such as Subscriber Identity Model card (SIM card), Secure Digital Memory card (SD card) or like can be inserted into an electronic device, so that the electronic device can communicate with other electronic devices or store information.

### BRIEF DESCRIPTION OF THE DRAWINGS

Many aspects of the present disclosure are better understood with reference to the follow drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is an isometric view of an embodiment of an electronic device.

FIG. 2 is a partial isometric view of the electronic device shown in FIG. 1.

FIG. 3 is a partial isometric view of the electronic device shown in FIG. 2 in a first state.

FIG. 4 is an enlarged view of a circle portion IV of FIG. 3.

FIG. 5 is a partial isometric view of the electronic device shown in FIG. 2 in a second state.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

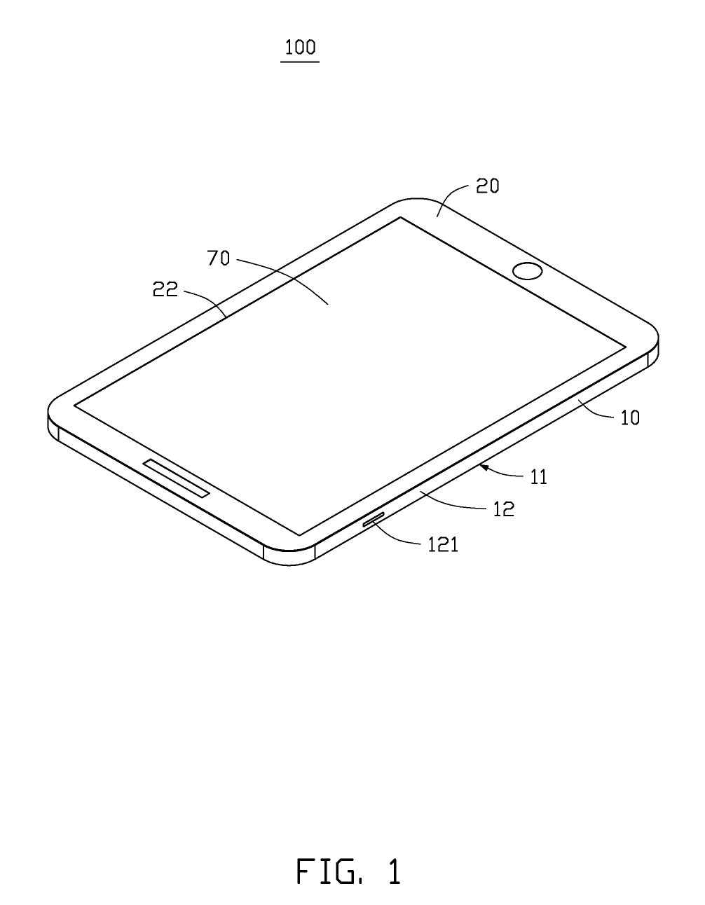

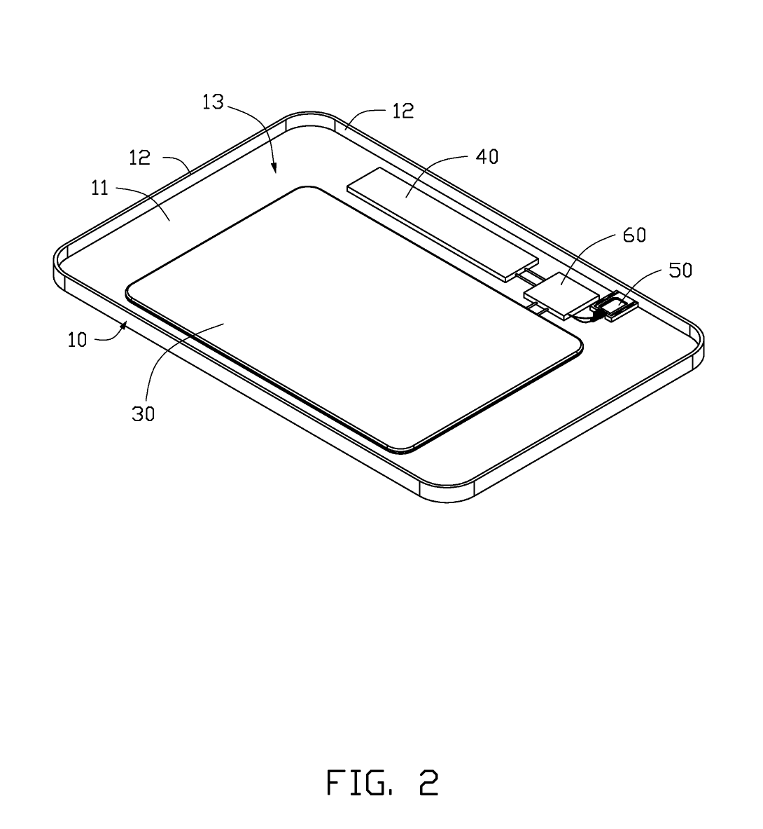

FIGS. 1 and 2 show an electronic device 100. The electronic device 100 can include a first shell 10, a second shell 20 coupled to the first shell 10, a power module 30, a processor 40, an electronic card connector 50, a current control module 60 and a touch screen 70. The electronic device 100 can also include other functional modules to fulfill different functions; however, it is not shown and specifically described for simplification.

The first shell 10 can be a rectangular shaped bottom shell. The first shell 10 can include a bottom plate 11 and four peripheral sidewalls 12. Each peripheral sidewall 12 can protrude from one edge of the bottom plate 11. Four peripheral sidewalls 12 can extend towards a same direction. The bottom plate 11 and the four peripheral sidewalls 12 can cooperatively define a receiving space 13. The receiving space 13 can be used to receive the power module 30, the processor 40, the electronic card connector 50 and the current control module 60 therein. One of the four peripheral sidewalls 12 can define a first opening 121 interconnected with the receiving space 13.

The second shell 20 can be a rectangular-shaped top shell. The second shell 20 can be rectangular-shaped and define a second opening 22 thereon. The second opening 22 can be rectangular shaped and used to receive the touch screen 70 therein. The second shell 20 can cover the first shell 10.

The power module 30 can be electrically coupled to the processor 40, the current control module 60 and the touch screen 70 and further used to power the processor 40, the current control module 60 and the touch screen 70. In at least one embodiment, the power module 30 can be but not limited to battery. The processor 40 can be electrically coupled to the touch screen 70 and the current control module 60.

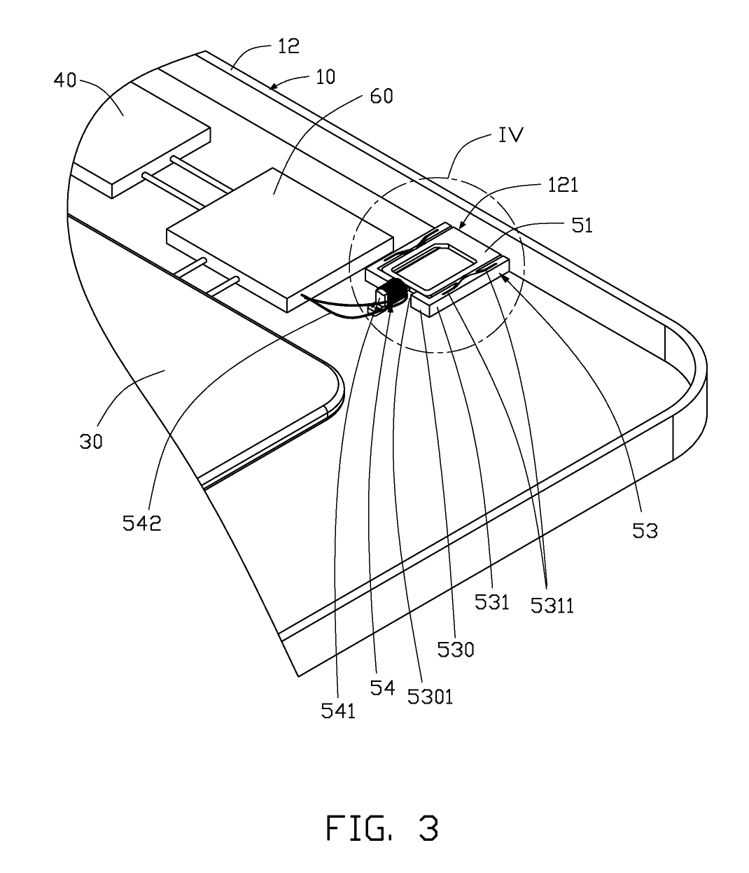

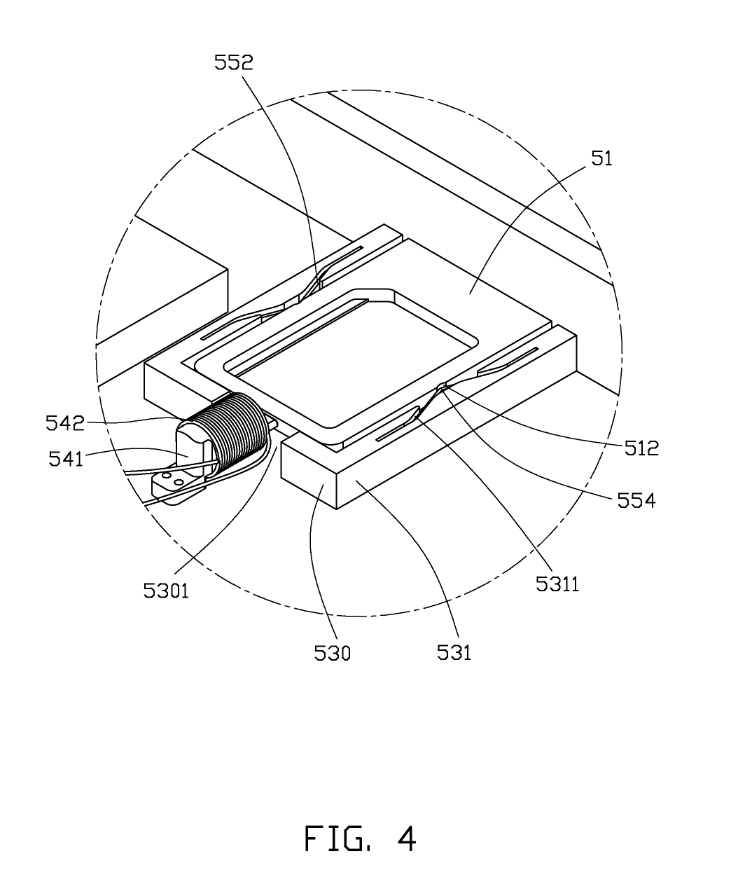

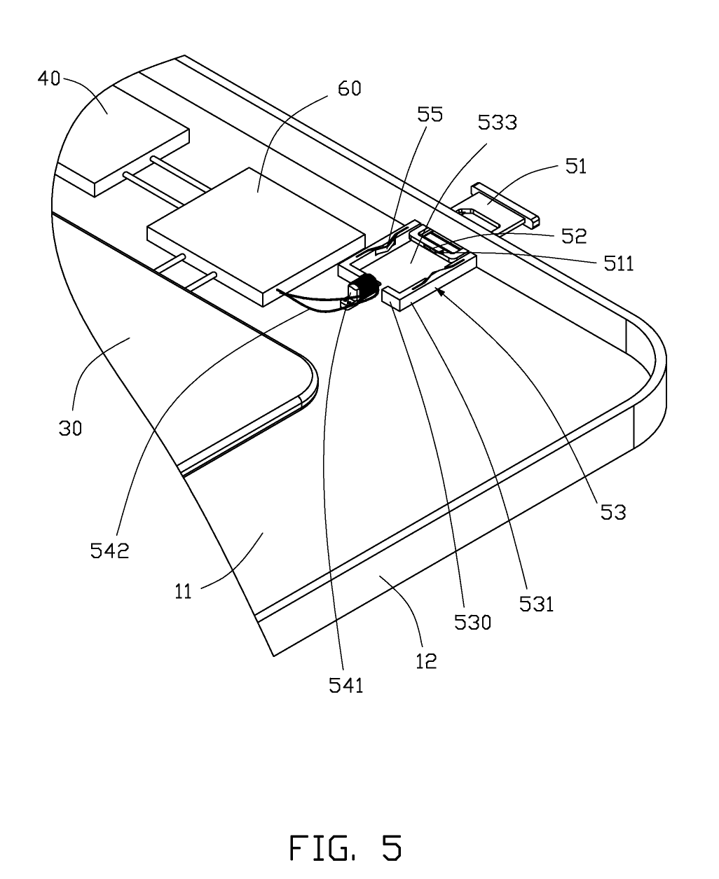

Referring to FIGS. 3-5, the electronic card connector 50 can include a tray 51 for accommodating an electronic card, a permanent magnet 52 mounted in the tray 51, a receiving member 53 for receiving the tray 51, an electromagnet 54 opposite to the permanent magnet 52 and at least one latching member 55 for latching the tray 51 with the receiving member 53. The details can be shown as follows.

The tray 51 can pass through the first opening 121 and further receive in the receiving space 13. In detail, the tray 51 can be rectangular shaped, and define a first notch 511 on one end of the tray 51 away from the one of the four peripheral sidewalls 12, and further define at least one second notch 512 on the two sides of the tray 51.

The permanent magnet 52 can receive in the first notch 511 and face with the electromagnet 54. The magnetism of one end of the permanent magnet 52 close to the electromagnet 54 can be same with that of one end of electromagnet 54 close to the permanent magnet 52. In this embodiment, the magnetism of one end of the permanent magnet 52 close to the electromagnet 54 and the magnetism of one end of electromagnet 54 close to the permanent magnet 52 can be both South. In at least one embodiment, the magnetism of one end of the permanent magnet 52 close to the electromagnet 54 and the magnetism of one end of electromagnet 54 close to the permanent magnet 52 can be both North.

The receiving member 53 can be, but not limited to, rectangular shaped, and resist the one of the four peripheral sidewalls 12 and further face the first opening 121. In detail, the receiving member 53 can include a first limited wall 530 and at least one second limited wall 531. The first limited wall 530, the at least one second limited wall 531 and the first shell 10 can cooperatively define an accommodating space 533 interconnected with the first opening 121. The accommodating space 533 can be used to receive the tray 51 therein.

The first limited wall 530 can be, but not limited to, quadrangular-shaped. The first limited wall 530 can face the first opening 121 and define a gap 5301. The gap 5301 can face the first notch 511 of the tray 51. Thus, the electromagnet 54 can partially receive in the gap 5301 and further face the permanent magnet 52 received in the first notch 511.

The at least one second limited wall 531 can be, but not limited to, quadrangular-shaped. The at least one second limited wall 531 can be located on at least one side of the tray 51. Each second limited wall 531 can define a strip-shaped slot 5311. Each strip-shaped slot 5311 can extend from the middle of the second limited wall 531 to the two ends of the second limited wall 531. In this embodiment, the at least one second limited wall 531 can include two second limited walls 531, and the two strip-shaped slots 5311 can face with each other.

The at least one latching member 55 can be V-shaped. Each latching member 55 can include two fixing ends 552 and a resisting portion 554 located between the two fixing ends 552. The two fixing ends 552 can be fixed to the receiving member 53, and the resisting portion 554 can protrude from the receiving member 53 and further receive in one of the at least one second notch 512 to engage the tray 51 with the receiving member 53. In this embodiment, the two fixing ends 552 of each latching member 55 can both receive in one slot 5311, the resisting portion 554 can protrude from the slot 5311 and further receive in one of the at least one second notch 512 to engage the tray 51 with the receiving member 53.

The electromagnet 54 can be attached to the bottom plate 11 of the first shell 10. The electromagnet 54 can include a metal cylinder 541 and a coil 542 twined on the metal cylinder 541. The metal cylinder 541 can be attached to the bottom plate 11 and further partially receive in the gap 5301. The coil 542 can be uniformly and separately distributed on the entire side of the metal cylinder 541. The two ends of the coil 542 can be electrically coupled to the current control module 60.

In this embodiment, the coil 542 can be twined on the metal cylinder 541 along a direction. When there is current flowing through the coil 542, the metal cylinder 541 can be magnetized and one end of the metal cylinder 541 close to the permanent magnet 52 can be magnetized to South pole. The magnetism of the end of the permanent magnet 52 close to the electromagnet 54 can be South. Thus, the permanent magnet 52 and the electromagnet 54 can be repelled with each other.

In at least one embodiment, the coil 542 can be twined on the metal cylinder 541 along other direction opposite to the direction. When there is current flowing through the coil 542, the metal cylinder 541 can be also magnetized and the one end of the metal cylinder 541 close to the permanent magnet 52 can be magnetized to North pole. The magnetism of the end of the permanent magnet 52 close to the electromagnet 54 can be North. Thus, the permanent magnet 52 and the electromagnet 54 can be repelled with each other.

The metal cylinder 541 can be made of, but not limited to, high-carbon steel. When the metal cylinder 541 is magnetized by current flowing through the coil 542, the electromagnet 54 and the permanent magnet 52 can be repelled with each other as like poles repel. When the metal cylinder 541 is de-magnetized by there is no current flowing through the coil 542, the electromagnet 54 can be attracted by the permanent magnet 52 as opposite poles attract.

The current control module 50 can be used to control the power module 30 to electrically couple with the coil 542 or disconnect with the coil 542. When the power module 30 is electrically coupled with the coil 542, the electromagnet 54 can be magnetized and repelled with the permanent magnet 52. When the power module 30 is disconnected with the coil 542, the electromagnet 54 can be de-magnetized and attracted with the permanent magnet 52.

Referring to FIGS. 1 and 3-5, the touch screen 70 can be used to generate input signals in response to an input applied on an icon (not shown) displayed thereon. The processor 40 can be used to generate control signals in response to the input signals. The current control module 50 can be used to control the power module 30 to electrically couple with the coil 542 or disconnect with the coil 542 in response to the control signals, thus to magnetize the electromagnet 54 or de-magnetize the electromagnet 54, thus to engage the tray 51 with the first shell 10 or disengage the tray 51 with the first shell 10.

If one wants to take out the electrical card from the electronic device 100, the icon displayed on the touch screen 70 can be touched to generate an input signal. The input signals can be transmitted to the processor 40. The control signals can be generated by the processor 40 in response to the input signals. The power module 30 can be controlled to electrically couple with the coil 542 in response to the control signals thus to cause the electromagnet 54 magnetized. The tray 51 can be pushed to overcome the resistance between the tray 51 and the second limited wall 531 and further pass through the first opening 121 by the electromagnet 54 thus to disengage with the first shell 10.

If one wants to put the electronic card in the electronic device 100, the icon displayed on the touch screen 70 can be touched to generate another input signal. The input signals can be transmitted to the processor 40. Another control signal can be generated by the processor 40 in response to the input signals. The power module 30 can be controlled to disconnect with the coil 542 in response to the control signals thus to cause the electromagnet 54 to de-magnetized. The tray 51 can be pushed to pass through the first opening 121 and further receive in the receiving member and can be further attracted by the electromagnet 54 thus to engage the tray 51 with the first shell 10.

The embodiments shown and described above are only examples. Many details are often found in the art. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. An electronic device comprising:
a first shell defining a first opening;
a second shell that covers the first shell;
a power module received in the first shell; and
an electronic card connector comprising
a tray for receiving an electronic card, the tray passing through the first opening to be received in the first shell;
a receiving member attached to the first shell for receiving the tray;
a permanent magnet mounted in the tray; and
an electromagnet attached to the first shell and facing the permanent magnet; and
a current control module electrically coupled with the power module and configured to control the power module to electrically couple with the electromagnet to magnetize the electromagnet or control the power module to disconnect with the electromagnet to de-magnetize the electromagnet, and when the electromagnet is de-magnetized, the tray is attracted by the permanent magnet to engage the tray with the first shell, and when the electromagnet is magnetized, the tray is driven to move out from the first opening by the permanent magnet to disengage the tray with the first shell.

2. The electronic device of claim 1, wherein the second shell defines a second opening; the electronic device further comprises
a touch screen received in the second opening; and
a processor electrically coupled to the touch screen, the power module and the current control module;
wherein the touch screen is configured to generate input signals in response to an input applied thereon, the processor is configured to generate control signals in response to the input signals, and the current control module is configured to control the power module to electrically couple with the electromagnet or disconnect with the electromagnet in response to the control signals.

3. The electronic device of claim 2, wherein the first shell comprises a bottom plate and four peripheral sidewalls, the bottom plate and the four peripheral sidewalls cooperatively define a receiving space for receiving the power module, the processor, the electronic card connector and the current control module therein.

4. The electronic device of claim 1, wherein the first shell comprises a peripheral sidewall, and the first opening is defined on the peripheral sidewall.

5. The electronic device of claim 1, wherein the tray defines a first notch, and the permanent magnet is received in the first notch and faces with the electromagnet.

6. The electronic device of claim 1, wherein the electromagnet comprises a metal cylinder and a coil, the metal cylinder is attached to the first shell, the coil is uniformly and separately distributed on an entire side of the metal cylinder, and electrically coupled to the current control module.

7. The electronic device of claim 1, wherein the first shell comprises a bottom plate, the tray defines a first notch, the receiving member is attached to the bottom plate, and the receiving member comprises a first limited wall facing the first opening and defining a gap facing the first notch, and the electromagnet is partially received in the gap and further faces the permanent magnet received in the first notch.

8. The electronic device of claim 1, wherein the tray defines at least one second notch, the electronic card connector comprises at least one latching member, each latching member comprises two fixing ends and a resisting portion located between the two fixing ends, the two fixing ends of each latching member are fixed to the receiving member and the resisting portion is received in one of the at least one second notch to engage the tray with the receiving member.

9. The electronic device of claim 8, wherein the receiving member comprises at least one second limited wall, and each second limited wall defines at least one slot, the two fixing ends of each latching member are received the at least one slot.
